(19) United States
(12) Patent Application Publication
(10) Pub. No.: US 2012/0173247 A1
(43) Pub. Date: Jul. 5, 2012

(54) APPARATUS FOR ENCODING AND DECODING AN AUDIO SIGNAL USING A WEIGHTED LINEAR PREDICTIVE TRANSFORM, AND A METHOD FOR SAME

(75) Inventors: Ho Sang Sung, Yongin-si (KR); Eun Mi Oh, Yongin-si (KR); Jung-Hoe Kim, Yongin-si (KR); Mi Young Kim, Yongin-si (KR)

(73) Assignee: SAMSUNG ELECTRONICS CO., LTD., Suwon-si (KR)

(21) Appl. No.: 13/381,522

(22) PCT Filed: Jun. 28, 2010
(86) PCT No.: PCT/KR10/04169

§ 371 Date: Mar. 15, 2012

(30) Foreign Application Priority Data
Jun. 29, 2009 (KR) 10-2009-0058530

(51) Int. Cl. G10L 19/00

(52) U.S. Cl. 704/500; 704/E19.001

(57) ABSTRACT

Disclosed is an apparatus for encoding and/or decoding an audio signal having a variable bit rate (VBR). A target bit rate is determined in accordance with characteristics of an audio signal, and a weighted linear predictive transform coding is performed in accordance with the determined target bit rate.

### CROSS-REFERENCE TO RELATED APPLICATIONS

This application is a national stage entry under 35 U.S.C. 371(c) of International Patent Application No. PCT/KR2010/004169, filed Jun. 28, 2010, and claims priority from Korean Patent Application No. 10-2009-0058530, filed on Jun. 29, 2009 in the Korean Intellectual Property Office, the disclosures of which are incorporated herein by reference in their entireties.

### TECHNICAL FIELD

Apparatuses and method consistent with exemplary embodiments relate to a technology for encoding and/or decoding an audio signal.

### BACKGROUND

Audio signal encoding refers to a technology of compressing original audio by extracting parameters relating to a human speech generation model. In audio signal encoding, an input audio signal is sampled at a certain sampling rate and is divided into temporal blocks or frames.

An audio encoding apparatus extracts certain parameters which are used to analyze an input audio signal, and quantizes the parameters to be represented as binary numbers, e.g., a set of bits or a binary data packet. A quantized bitstream is transmitted to a receiver or a decoding apparatus via a wired or wireless channel, or is stored in any of various recording media. The decoding apparatus processes audio frames included in the bitstream, generates parameters by dequantizing the audio frames, and restores an audio signal by using the parameters.

Currently, research is being conducted on a method for encoding a superframe including a plurality of frames at an optimal bit rate. If a perceptually non-sensitive audio signal is encoded at a low bit rate and a perceptually sensitive audio signal is encoded at a high bit rate, an audio signal may be efficiently encoded while minimizing deterioration of sound quality.

### DETAILED DESCRIPTION OF THE INVENTION

### Technical Problem

Exemplary embodiments described in the present disclosure may efficiently encode an audio signal while minimizing deterioration of sound quality.

Exemplary embodiments may improve sound quality in an unvoiced sound period.

### Technical Solution

According to an aspect of one or more exemplary embodiments, there is provided an audio signal encoder, including a mode selection unit which selects an encoding mode relating to an audio frame; a bit rate determination unit which determines a target bit rate of the audio frame based on the selected encoding mode; and a weighted linear prediction transformation encoding unit which performs a weighted linear prediction transformation encoding operation on the audio frame based on the determined target bit rate.

According to another aspect of one or more exemplary embodiments, there is provided an audio signal decoder, including a bit rate determination unit which determines a bit rate of an encoded audio frame; and a weighted linear prediction transformation decoding unit which performs a weighted linear prediction transformation decoding operation on the audio frame based on the determined bit rate.

According to another aspect of one or more exemplary embodiments, there is provided a method for encoding an audio signal, the method including selecting an encoding mode relating to an audio frame; determining a bit rate of the audio frame based on the selected encoding mode; and performing weighted linear prediction transformation encoding on the audio frame based on the determined bit rate.

### Effect of the Exemplary Embodiments

In accordance with one or more exemplary embodiments, the size of an encoded audio signal may be reduced while minimizing deterioration of sound quality.

In accordance with one or more exemplary embodiments, sound quality may be improved in an unvoiced sound period of an encoded audio signal.

### BRIEF DESCRIPTION OF THE DRAWINGS

FIG. 1 is a block diagram of an audio signal encoding apparatus according to an exemplary embodiment.

FIG. 2 is a block diagram of an encoder for encoding an audio signal by using a plurality of linear predictions, according to an exemplary embodiment.

FIG. 3 is a block diagram of an audio signal decoder according to an exemplary embodiment.

FIG. 4 is a block diagram of a weighted linear prediction transformation decoding unit for decoding an audio signal by using a plurality of linear predictions, according to an exemplary embodiment.

FIG. 5 is a block diagram of an encoder for encoding an audio signal by performing temporal noise shaping (TNS), according to an exemplary embodiment.

FIG. 6 is a block diagram of a decoder for decoding a temporal-noise-shaped (“TNSed”) audio signal, according to an exemplary embodiment.

FIG. 7 is a block diagram of an encoder for encoding an audio signal by using a codebook, according to an exemplary embodiment.

FIG. 8 is a block diagram of a decoder for decoding an audio signal by using a codebook, according to an exemplary embodiment.

FIG. 9 is a block diagram of a mode selection unit for determining an encoding mode relating to an audio signal, according to an exemplary embodiment.

FIG. 10 is a flowchart illustrating a method for encoding an audio signal by performing weighted linear prediction transformation, according to an exemplary embodiment.

FIG. 11 is a flowchart illustrating a method for encoding an audio signal by using a plurality of linear predictions, according to an exemplary embodiment.

FIG. 12 is a flowchart illustrating a method for encoding an audio signal by performing TNS, according to an exemplary embodiment.

FIG. 13 is a flowchart illustrating a method for encoding an audio signal by using a codebook, according to an exemplary embodiment.

### DESCRIPTION OF THE EXEMPLARY EMBODIMENTS

Hereinafter, exemplary embodiments will be described in detail with reference to the attached drawings.

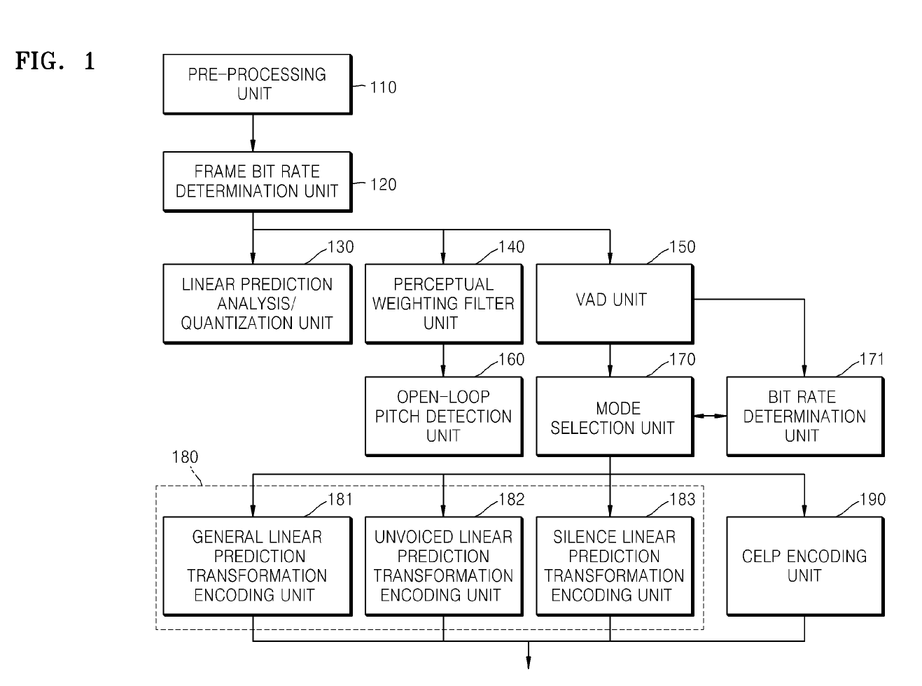

FIG. 1 is a block diagram of an audio signal encoding apparatus according to an exemplary embodiment. Referring to FIG. 1, the audio signal encoding apparatus includes a mode selection unit 170, a bit rate determination unit 171, a general linear prediction transformation encoding unit 181, an unvoiced linear prediction transformation encoding unit 182, and a silence linear prediction transformation encoding unit 183.

A pre-processing unit 110 may remove an undesired frequency component from an input audio signal, and may perform pre-filtering to adjust frequency characteristics for encoding the audio signal. For example, the pre-processing unit 110 may use pre-emphasis filtering according to the adaptive multi-rate wideband (AMR-WB) standard. In particular, the input audio signal is sampled to a predetermined sampling frequency that is appropriate for encoding. For example, a narrowband audio encoder may have a sampling frequency of 8000 Hz, and a wideband audio encoder may have a sampling frequency of 16000 Hz.

The audio signal encoding apparatus may encode an audio signal in units of a superframe which includes a plurality of frames. For example, the superframe may include four frames. Accordingly, in this example, each superframe is encoded by encoding four frames. For example, if the superframe has a size of 1024 samples, each of the four frames has a size of 256 samples. In this case, the superframe may be adjusted to have a larger size and to overlap with another superframe by performing an overlap and add (OLA) process.

A frame bit rate determination unit 120 may determine a bit rate of an audio frame. For example, the frame bit rate determination unit 120 may determine a bit rate of a current superframe by comparing a target bit rate to a bit rate of a previous frame.

A linear prediction analysis/quantization unit 130 extracts a linear prediction coefficient by using the filtered input audio frame. In particular, the linear prediction analysis/quantization unit 130 transforms the linear prediction coefficient into a coefficient that is appropriate for quantization (e.g., an immittance spectral frequency (ISF) or line spectral frequency (LSF) coefficient), and quantizes the coefficient by using any of various quantization methods (e.g., vector quantization). The extracted linear prediction coefficient and the quantized linear prediction coefficient are transmitted to a perceptual weighting filter unit 140.

The perceptual weighting filter unit 140 filters the pre-processed signal by using a perceptual weighting filter. The perceptual weighting filter unit 140 reduces quantization noise to be within a masking range in order to use a masking effect of an auditory structure of the human body. The signal filtered by the perceptual weighting filter unit 140 may be transmitted to an open-loop pitch detection unit 160.

The open-loop pitch detection unit 160 detects an open-loop pitch by using the signal filtered by and transmitted from the perceptual weighting filter unit 140.

A voice activity detection (VAD) unit 150 receives the audio signal filtered by the pre-processing unit 110, and detects voice activity of the filtered audio signal. For example, detectable characteristics of the input audio signal may include tilt information in the frequency domain, and energy information in each bark band.

The mode selection unit 170 determines an encoding mode relating to the audio signal by applying an open-loop method or a closed-loop method, according to the characteristics of the audio signal.

The mode selection unit 170 may classify a current frame of the audio signal before selecting an optimal encoding mode. In particular, the mode selection unit 170 may divide the current audio frame into low-energy noise, noise, unvoiced sound, and a residual signal by using a result of detecting the unvoiced sound. In this case, the mode selection unit 170 may select an encoding mode relating to the current audio frame based on a result of the classifying. The encoding mode may include one of a general linear prediction transformation encoding mode, an unvoiced linear prediction transformation encoding mode, a silence linear prediction transformation encoding mode, and a variable bit rate (VBR) voiced linear prediction transformation encoding mode (e.g., an algebraic code-excited linear prediction (ACELP) encoding mode), for encoding the audio signal included in a superframe which includes a plurality of audio frames.

The bit rate determination unit 171 determines a target bit rate of the audio frame based on the encoding mode selected by the mode selection unit 170. For example, the mode selection unit 170 may determine that the audio signal included in the audio frame corresponds to silence, and may select the silence linear prediction transformation encoding mode as an encoding mode of the audio frame. In this case, the bit rate determination unit 171 may determine the target bit rate of the audio frame to be relatively low. Alternatively, the mode selection unit 170 may determine that the audio signal included in the audio frame corresponds to a voiced sound. In this case, the bit rate determination unit 171 may determine the target bit rate of the audio frame to be relatively high.

A linear prediction transformation encoding unit 180 may encode the audio frame by activating one of the general linear prediction transformation encoding unit 181, the unvoiced linear prediction transformation encoding unit 182, and the silence linear prediction transformation encoding unit 183 based on the encoding mode selected by the mode selection unit 170.

If the mode selection unit 170 selects a code-excited linear prediction (CELP) encoding mode as the encoding mode of the audio frame, a CELP encoding unit 190 encodes the audio frame according to the CELP encoding mode. According to an exemplary embodiment, the CELP encoding unit 190 may encode every audio frame according to a different bit rate with reference to the target bit rate of the audio frame.

Although the target bit rate of the audio frame is determined on the basis of the encoding mode selected by the mode selection unit 170 in the above description, the encoding mode of the audio frame may also be determined on the basis of the target bit rate determined by the bit rate determination unit 171. If the bit rate determination unit 171 determines the target bit rate of the audio frame based on the characteristics of the audio signal, the mode selection unit 170 may select an encoding mode for achieving the best sound quality within the target bit rate determined by the bit rate determination unit 171.

The mode selection unit 170 may encode the audio frame according to each of a plurality of encoding modes. The mode selection unit 170 may compare the encoded audio frames, and may select an encoding mode for achieving the best sound quality. The mode selection unit 170 may measure characteristics of the encoded audio frames, and may determine the encoding mode by comparing the measured characteristics to a certain reference value. The characteristics of the audio frames may be signal-to-noise ratios (SNRs) of the audio frames. The mode selection unit 170 may compare the measured SNRs to a certain reference value, and may select an encoding mode corresponding to an SNR greater than the reference value. According to another exemplary embodiment, the mode selection unit 170 may select an encoding mode corresponding to the highest SNR.

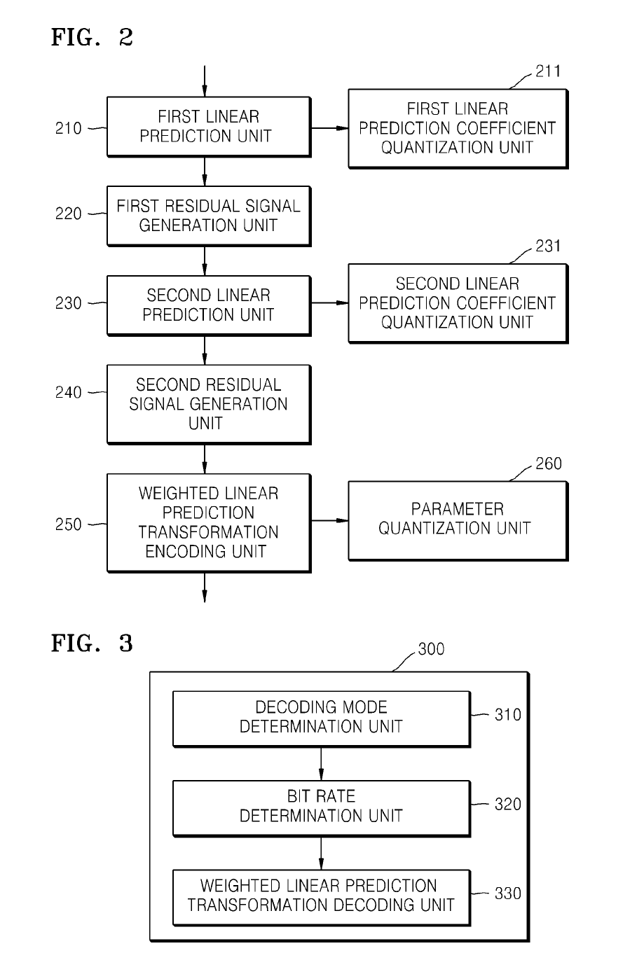

FIG. 2 is a block diagram of an encoder for encoding an audio signal by using a plurality of linear predictions, according to an exemplary embodiment. The audio signal encoder includes a first linear prediction unit 210, a first residual signal generation unit 220, a second linear prediction unit 230, a second residual signal generation unit 240, and a weighted linear prediction transformation encoding unit 250.

The first linear prediction unit 210 generates first linear prediction data and a first linear prediction coefficient by performing linear prediction on an audio frame. A first linear prediction coefficient quantization unit 211 may quantize the first linear prediction coefficient. An audio signal decoder may restore the first linear prediction data by using the first linear prediction coefficient.

The first residual signal generation unit 220 generates a first residual signal by removing the first linear prediction data from the audio frame. The first residual signal generation unit 220 may generate the first linear prediction data by analyzing an audio signal in a plurality of audio frames or a single audio frame, and predicting a variation in a value of the audio signal. If a value of the first linear prediction data is very similar to the value of the audio signal, a range of a value of the first residual signal obtained by removing the first linear prediction data from the audio frame is relatively narrow. Accordingly, if the first residual signal is encoded instead of the audio signal, the audio frame may be encoded by using only a relatively small number of bits.

The second linear prediction unit 230 generates second linear prediction data and a second linear prediction coefficient by performing linear prediction on the first residual signal. A second linear prediction coefficient quantization unit 231 may quantize the second linear prediction coefficient. The audio signal decoder may generate the first linear prediction data by using the second linear prediction coefficient.

The second residual signal generation unit 240 generates a second residual signal by removing the second linear prediction data from the first residual signal. In general, a range of a value of the second residual signal is narrower than the range of the value of the first residual signal. Accordingly, if the second residual signal is encoded, the audio frame may be encoded by using a smaller number of bits.

The weighted linear prediction transformation encoding unit 250 may generate parameters such as, for example, a codebook index, a codebook gain, and a noise level, by performing weighted linear prediction transformation encoding on the second residual signal. A parameter quantization unit 260 may quantize the parameters generated by the weighted linear prediction transformation encoding unit 250, and may also quantize the encoded second residual signal.

The audio signal decoder may decode the encoded audio frame based on the quantized second residual signal, the quantized parameters, the quantized first linear prediction coefficient, and the quantized second linear prediction coefficient.

FIG. 3 is a block diagram of an audio signal decoder 300 according to an exemplary embodiment. The audio signal decoder 300 includes a decoding mode determination unit 310, a bit rate determination unit 320, and a weighted linear prediction transformation decoding unit 330.

The decoding mode determination unit 310 determines a decoding mode relating to an audio frame. Since audio signals included in different audio frames have different characteristics, the audio frames may have been encoded according to different encoding modes. The decoding mode determination unit 310 may determine a decoding mode corresponding to an encoding mode used for each audio frame.

The bit rate determination unit 320 determines a bit rate of the audio frame. Since audio signals included in different audio frames have different characteristics, the audio frames may have been encoded according to different bit rates. The bit rate determination unit 320 may determine a bit rate of each audio frame.

The bit rate determination unit 320 may determine a bit rate with reference to the determined decoding mode.

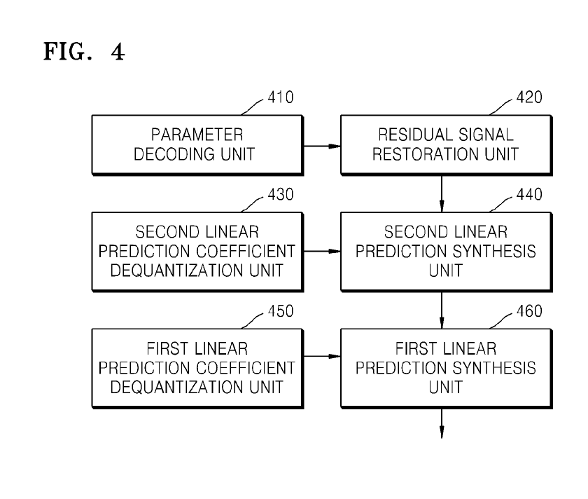

The weighted linear prediction transformation decoding unit 330 performs weighted prediction transformation decoding on the audio frame on the basis of the determined bit rate and the determined decoding mode. Various examples of the weighted linear prediction transformation decoding unit 330 will be described in detail below with reference to FIGS. 4, 6, and 8.

FIG. 4 is a block diagram of a weighted linear prediction transformation decoding unit for decoding an audio signal by using a plurality of linear predictions, according to an exemplary embodiment. The weighted linear prediction transformation decoding unit includes a parameter decoding unit 410, a residual signal restoration unit 420, a second linear prediction coefficient dequantization unit 430, a second linear prediction synthesis unit 440, a first linear prediction coefficient dequantization unit 450, and a first linear prediction synthesis unit 460.

The parameter decoding unit 410 decodes quantized parameters, such as, for example, a codebook index, a codebook gain, and a noise level. The parameters may be included in an encoded audio frame as a part of an audio signal. The residual signal restoration unit 420 restores a second residual signal with reference to the decoded codebook index and the decoded codebook gain. The codebook may include a plurality of components which are distributed according to a Gaussian distribution. The residual signal restoration unit 420 may select one of the components from the codebook by using the codebook index, and may restore the second residual signal based on the selected component and the codebook gain.

The second linear prediction coefficient dequantization unit 430 restores a quantized second linear prediction coefficient. The second linear prediction synthesis unit 440 may restore second linear prediction data by using the second linear prediction coefficient. The second linear prediction synthesis unit 440 may restore a first residual signal by combining the restored second linear prediction data and the second residual signal.

The first linear prediction coefficient dequantization unit 450 restores a quantized first linear prediction coefficient. The first linear prediction synthesis unit 460 may restore first linear prediction data by using the first linear prediction coefficient. The first linear prediction synthesis unit 460 may decode an audio signal by combining the restored first linear prediction data and the second residual signal.

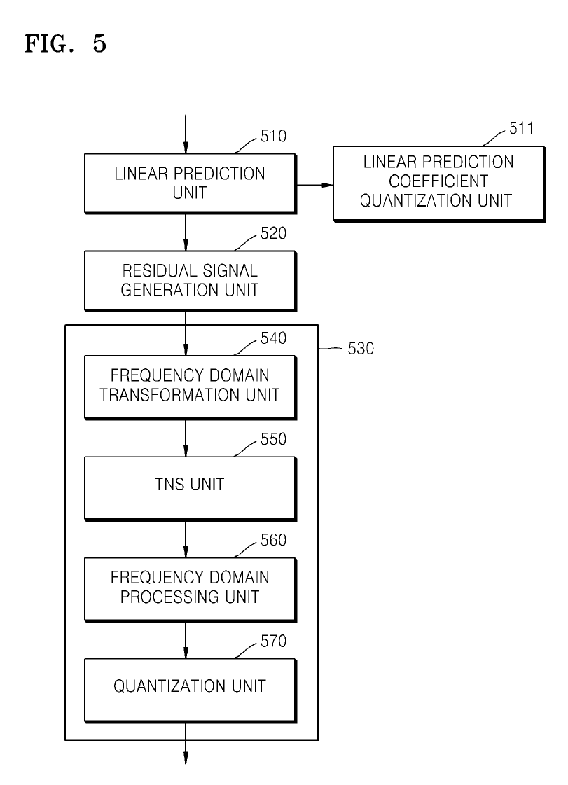

FIG. 5 is a block diagram of an encoder for encoding an audio signal by performing temporal noise shaping (TNS), according to an exemplary embodiment. The audio signal encoder includes a linear prediction unit 510, a linear prediction coefficient quantization unit 511, a residual signal generation unit 520, and a weighted linear prediction transformation encoding unit 530.

The weighted linear prediction transformation encoding unit 530 may include a frequency domain transformation unit 540, a TNS unit 550, a frequency domain processing unit 560, and a quantization unit 570.

The linear prediction unit 510 generates linear prediction data and a linear prediction coefficient by performing linear prediction on an audio frame. The linear prediction coefficient quantization unit 511 may quantize the linear prediction coefficient. An audio signal decoder may restore the linear prediction data by using the linear prediction coefficient.

The residual signal generation unit 520 generates a residual signal by removing the linear prediction data from the audio frame. The weighted linear prediction transformation encoding unit 530 may encode a high-quality audio signal based on a relatively low bit rate by encoding the residual signal.

The frequency domain transformation unit 540 transforms the residual signal from the time domain to the frequency domain. The frequency domain transformation unit 540 may transform the residual signal to the frequency domain by performing, for example, fast Fourier transformation (FFT) or modified discrete cosine transformation (MDCT).

The TNS unit 550 performs TNS on the transformed residual signal (i.e., the result of transforming the residual signal to the frequency domain, hereinafter referred to as the “frequency domain residual signal”). TNS is a method for intelligently reducing an error generated when continuous analog music data is quantized into digital data, so as to reduce noise and to achieve a sound that approximates the original. If a signal is abruptly generated in the time domain, an encoded audio signal has noise due to, for example, a pre-echo. TNS may be performed to reduce the noise caused by the pre-echo.

The frequency domain processing unit 560 may perform various types of processing in the frequency domain to improve the quality of an audio signal and to facilitate encoding.

The quantization unit 570 quantizes the temporal-noise-shaped (i.e., “TNSed”) residual signal.

In FIG. 5, noise associated with an encoded audio signal may be reduced by performing TNS. Accordingly, a high-quality audio signal may be encoded according to a relatively low bit rate.

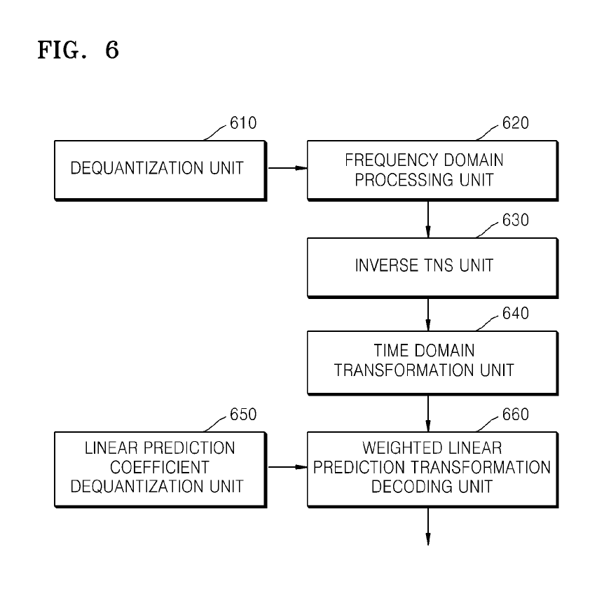

FIG. 6 is a block diagram of a decoder for decoding a TNSed audio signal, according to an exemplary embodiment. The audio signal decoder includes a dequantization unit 610, a frequency domain processing unit 620, an inverse TNS unit 630, a time domain transformation unit 640, a linear prediction coefficient dequantization unit 650, and a weighted linear prediction transformation decoding unit 660.

The dequantization unit 610 restores a residual signal by dequantizing a quantized residual signal included in a frame. The residual signal restored by the dequantization unit 610 may be a residual signal of the frequency domain.

The frequency domain processing unit 620 may perform various types of processing in the frequency domain to improve the quality of an audio signal and to facilitate encoding.

The inverse TNS unit 630 performs inverse TNS on the dequantized residual signal. Inverse TNS is performed to remove noise generated due to quantization. If a signal abruptly generated in the time domain has noise due to a pre-echo when quantization is performed, the inverse TNS unit 630 may reduce or remove the noise.

The time domain transformation unit 640 transforms the inverse TNSed residual signal to the time domain.

The linear prediction coefficient dequantization unit 650 dequantizes a quantized linear prediction coefficient included in an audio frame. The weighted linear prediction transformation decoding unit 660 generates linear prediction data based on the dequantized linear prediction coefficient, and performs linear prediction decoding on an encoded audio signal by combining the linear prediction data and the transformed residual signal (i.e., the time domain residual signal).

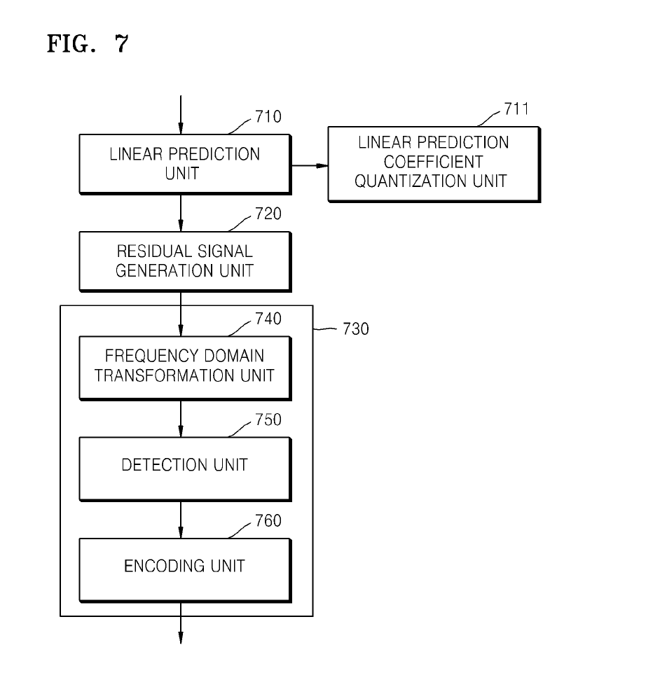

FIG. 7 is a block diagram of an encoder for encoding an audio signal by using a codebook, according to an exemplary embodiment. The audio signal encoder includes a linear prediction unit 710, a linear prediction coefficient quantization unit 711, a residual signal generation unit 720, and a weighted linear prediction transformation encoding unit 730. Respective operations of the linear prediction unit 710, the linear prediction coefficient quantization unit 711, and the residual signal generation unit 720 are similar to the corresponding operations of the linear prediction unit 510, the linear prediction coefficient quantization unit 511, and the residual signal generation unit 520 illustrated in FIG. 5, and thus detailed descriptions thereof will not be provided here.

The weighted linear prediction transformation encoding unit 730 may include a frequency domain transformation unit 740, a detection unit 750, and an encoding unit 760.

The frequency domain transformation unit 740 transforms a residual signal from the time domain to the frequency domain. The frequency domain transformation unit 740 may transform the residual signal to the frequency domain by performing, for example, FFT or MDCT.

The detection unit 750 searches for and detects a component corresponding to the transformed residual signal (i.e., the frequency domain residual signal), from among a plurality of components included in a codebook. The detected component may be a component similar to the residual signal from among the components included in the codebook. The components of the codebook may be distributed according to a Gaussian distribution.

The encoding unit 760 encodes a codebook index of the detected component, which corresponds to the residual signal.

The audio signal encoder may encode, instead of the residual signal, the codebook index. The detected component of the codebook is similar to the residual signal, and the corresponding codebook index has a relatively small size in comparison to the residual signal. Accordingly, a high-quality audio signal may be encoded according to a relatively low bit rate.

An audio signal decoder may decode the codebook index and may extract the corresponding component of the codebook with reference to the decoded codebook index.

Although an audio signal is encoded by performing linear prediction once and by using the codebook in the exemplary embodiment illustrated in FIG. 7, according to another exemplary embodiment, the audio signal may be encoded by performing linear prediction a plurality of times and by using the codebook. Similarly as illustrated in FIG. 2, the linear prediction unit 710 may generate second linear prediction data by performing linear prediction on the residual signal. The residual signal generation unit 720 generates a second residual signal by removing the second linear prediction data from the residual signal.

The detection unit 750 may detect a component corresponding to the second residual signal from among the components of the codebook, and the encoding unit 760 may encode a codebook index of the detected component corresponding to the second residual signal.

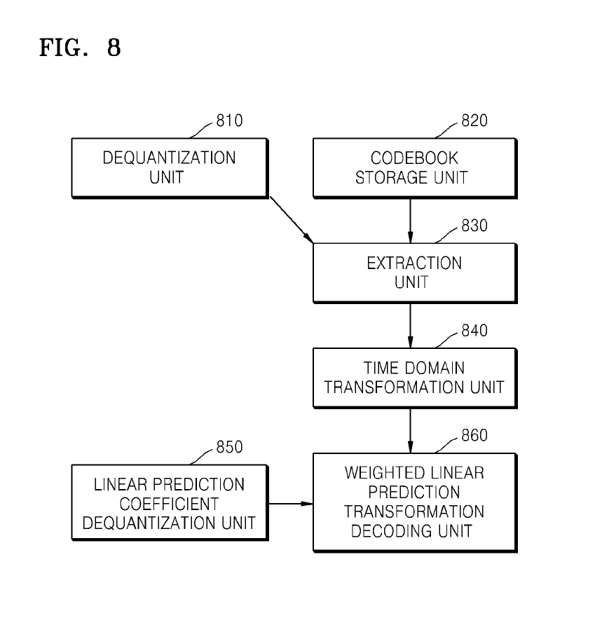

FIG. 8 is a block diagram of a decoder for decoding an audio signal by using a codebook, according to an exemplary embodiment. The audio signal decoder includes a dequantization unit 810, a codebook storage unit 820, an extraction unit 830, a time domain transformation unit 840, a linear prediction coefficient dequantization unit 850, and a weighted linear prediction transformation decoding unit 860.

The dequantization unit 810 dequantizes a quantized codebook index included in an audio frame.

The codebook storage unit 820 stores a codebook which includes a plurality of components. The components included in the codebook may be distributed according to a Gaussian distribution.

The extraction unit 830 extracts one of the components from the codebook with references to a codebook index. The codebook index may indicate a component similar to the residual signal from among the components of the codebook. The extraction unit 830 may extract a component of the codebook based on a similarity to the residual signal with reference to a dequantized codebook index.

The time domain transformation unit 840 transforms the extracted component of the codebook to the time domain.

The linear prediction coefficient dequantization unit 850 dequantizes a quantized linear prediction coefficient included in the audio frame. The weighted linear prediction transformation decoding unit 860 generates linear prediction data based on the dequantized linear prediction coefficient, and performs weighted linear prediction transformation decoding on an encoded audio signal by combining the linear prediction data and the time-domain-transformed component of the codebook.

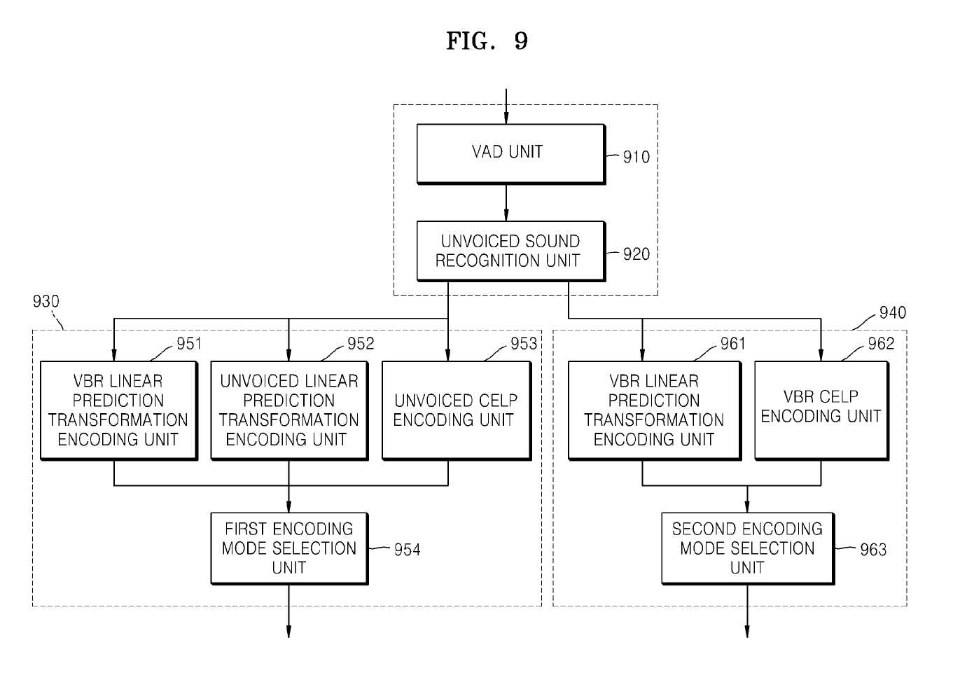

FIG. 9 is a block diagram of a mode selection unit for determining an encoding mode relating to an audio signal, according to an exemplary embodiment. The mode selection unit includes a VAD unit 910, an unvoiced sound recognition unit 920, an unvoiced sound encoding unit 930, and a voiced sound encoding unit 940.

The VAD unit 910 detects voice activity of an audio signal included in an audio frame. If the voice activity of the audio signal is less than a certain threshold value, the VAD unit 910 may determine that the audio signal corresponds to silence.

The unvoiced sound recognition unit 920 recognizes whether the audio signal corresponds to an unvoiced sound or a voiced sound. The unvoiced sound is a sound in which the vocal chords do not vibrate, and the voiced sound is a sound in which the vocal chords vibrate.

If the unvoiced sound recognition unit 920 recognizes that the audio signal included in the audio frame corresponds to an unvoiced sound, the unvoiced sound encoding unit 930 may encode the audio signal.

The unvoiced sound encoding unit 930 may include a variable bit rate (VBR) linear prediction transformation encoding unit 951, an unvoiced linear prediction transformation encoding unit 952, and an unvoiced CELP encoding unit 953. If the audio signal corresponds to an unvoiced sound, the VBR linear prediction transformation encoding unit 951, the unvoiced linear prediction transformation encoding unit 952, and the unvoiced CELP encoding unit 953 respectively encode the audio signal according to a linear prediction transformation encoding mode, an unvoiced linear prediction transformation encoding mode, and an unvoiced CELP encoding mode.

The first encoding mode selection unit 954 may select an encoding mode based on characteristics of the audio frame encoded according to each mode. The characteristics of the audio frame may include, for example, an SNR of the audio frame. Accordingly, the first encoding mode selection unit 954 may select an encoding mode based on an SNR of the audio frame encoded according to each mode. The first encoding mode selection unit 954 may select an encoding mode corresponding to a relatively high SNR of an encoded audio frame as an encoding mode of an input audio frame.

Although the first encoding mode selection unit 954 selects an encoding mode from among three modes in the exemplary embodiment illustrated in FIG. 9, according to another exemplary embodiment, the first encoding mode selection unit 954 may select an encoding mode from among two modes, such as, for example, the VBR linear prediction transformation mode and the unvoiced linear prediction transformation encoding mode; or from among any number of modes provided as inputs to the first encoding mode selection unit 954.

According to still another exemplary embodiment, the first encoding mode selection unit 954 may select an encoding mode based on an SNR of the encoded audio frame by varying an offset of each mode. In particular, the first encoding mode selection unit 954 may encode the audio frame by varying an offset of the VBR linear prediction transformation encoding unit 951 and an offset of the unvoiced linear prediction transformation encoding unit 952, and may compare SNRs of the encoded audio frames. Even when the offset of the VBR linear prediction transformation encoding unit 951 is greater than the offset of the unvoiced linear prediction transformation encoding unit 952, if an SNR of the audio frame encoded according to the VBR linear prediction transformation encoding mode is higher than the SNR of the audio frame encoded according to the unvoiced linear prediction transformation encoding mode, the VBR linear prediction transformation encoding mode may be selected as the encoding mode.

An optimal encoding mode may be selected by encoding the audio frame by varying an offset of each mode, and selecting an encoding mode having a relatively high SNR.

If the unvoiced sound recognition unit 920 recognizes that the audio signal included in the audio frame corresponds to a voiced sound, the voiced sound encoding unit 940 may encode the audio frame.

The voiced sound encoding unit 940 may include a VBR linear prediction transformation encoding unit 961, and a VBR CELP encoding unit 962.

The VBR linear prediction transformation encoding unit 961 and the VBR CELP encoding unit 962 respectively encode the audio frame according to a VBR linear prediction transformation encoding mode and a VBR CELP encoding mode.

The second encoding mode selection unit 963 may select an encoding mode based on characteristics of the audio frame encoded according to each mode. The characteristics of the audio frame may include, for example, an SNR of the audio frame. Accordingly, the second encoding mode selection unit 963 may select an encoding mode corresponding to a relatively high SNR of an encoded audio frame as an encoding mode of an input audio frame.

Although the VAD unit 910 is included in the mode selection unit in FIG. 9, according to another exemplary embodiment, the VAD unit 910 may be separate from the mode selection unit.

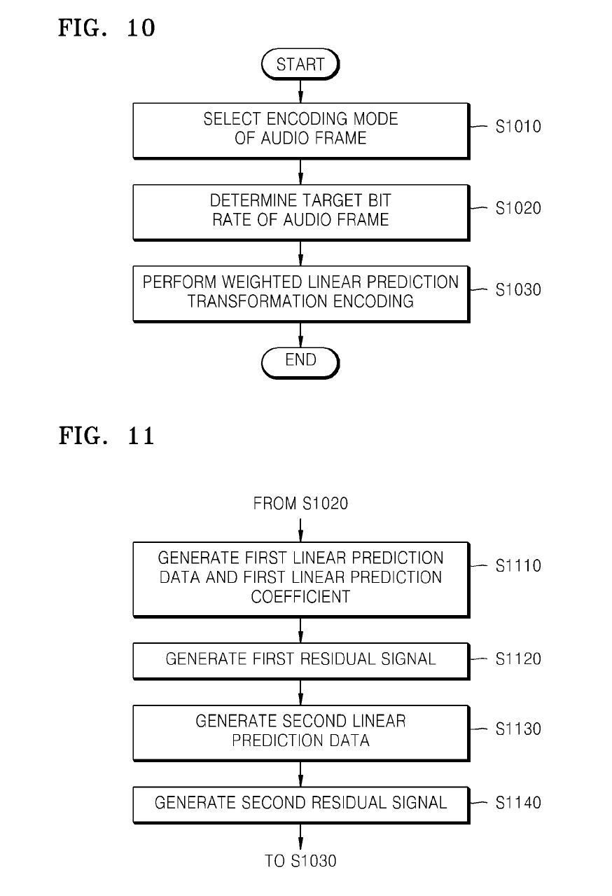

FIG. 10 is a flowchart illustrating a method for encoding an audio signal by performing weighted linear prediction transformation, according to an exemplary embodiment.

In operation S1010, an encoding mode of an audio frame is selected. The encoding mode may be selected from among, for example, an unvoiced weighted linear prediction transformation encoding mode and an unvoiced CELP encoding mode. The encoding mode may be selected based on an SNR of the audio frame encoded according to each mode. In particular, if an SNR of the audio frame encoded according to the unvoiced weighted linear prediction transformation encoding mode is higher than the SNR of the audio frame encoded according to the unvoiced CELP encoding mode, the unvoiced weighted linear prediction transformation encoding mode may be selected as the encoding mode.

In operation S1020, a target bit rate of the audio frame is determined on the basis of the encoding mode selected in operation S1010. The unvoiced weighted linear prediction transformation encoding mode may be selected as the encoding mode in operation S1010, which indicates that an audio signal included in the audio frame corresponds to an unvoiced sound. If the audio signal corresponds to an unvoiced sound, a relatively low target bit rate may be determined. A voiced CELP encoding mode may be selected as the encoding mode in operation S1010, which indicates that the audio signal corresponds to a voiced sound. If the audio signal corresponds to a voiced sound, a relatively high target bit rate may be determined.

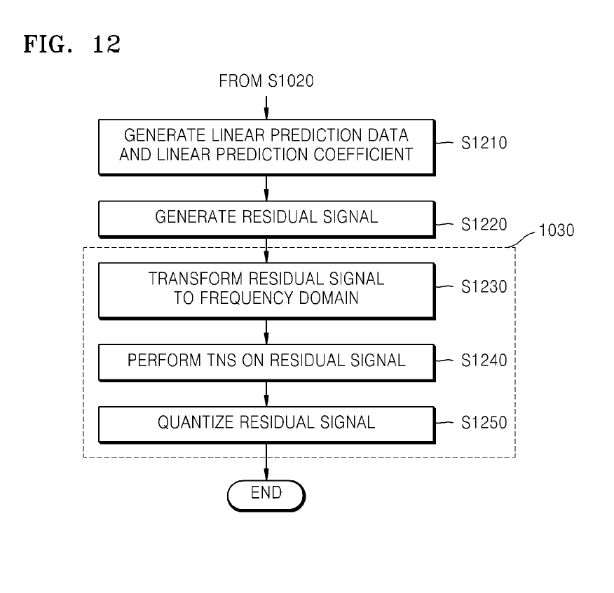

In operation S1030, weighted linear prediction transformation encoding is performed on the audio frame on the basis of the determined target bit rate and the selected encoding mode. The audio frame may be encoded, for example, by performing linear prediction a plurality of times, by performing TNS, or by using a codebook. Each of these methods for encoding the audio frame will now be described in detail with reference to FIGS. 11 through 13.

FIG. 11 is a flowchart illustrating a method for encoding an audio signal by performing linear prediction a plurality of times, according to an exemplary embodiment.

In operation S1110, first linear prediction data and a first linear prediction coefficient are generated by performing linear prediction on an audio frame. An audio signal decoder may restore the first linear prediction data based on the first linear prediction coefficient.

In operation S1120, a first residual signal is generated by removing the first linear prediction data from the audio frame. If an audio signal included in the audio frame is accurately predicted, the first linear prediction data is similar to the audio signal. Accordingly, the size of the first residual signal is less than the size of the audio signal.

In operation S1130, second linear prediction data and a second linear prediction coefficient are generated by performing linear prediction on the first residual signal. The audio signal decoder may restore the second linear prediction data based on the second linear prediction coefficient.

In operation S1140, a second residual signal is generated by removing the second linear prediction data from the first residual signal.

In operation S1030, the second residual signal is encoded. The size of the second residual signal is less than each of the respective sizes of the first residual signal and the audio signal. Accordingly, even when the audio signal is encoded according to a relatively low bit rate, the quality of the audio signal may be continuously maintained.

FIG. 12 is a flowchart illustrating a method for encoding an audio signal by performing TNS, according to an exemplary embodiment.

In operation S1210, linear prediction data and a linear prediction coefficient are generated by performing linear prediction on an audio frame. An audio signal decoder may restore the linear prediction data based on the linear prediction coefficient.

In operation S1220, a residual signal is generated by removing the linear prediction data from the audio frame.

In operation S1030, weighted linear prediction transformation encoding is performed on the residual signal. Operation S1030 will now be described in detail with respect to the exemplary embodiment illustrated in FIG. 12.

In operation S1230, the residual signal is transformed to the frequency domain. The residual signal may be transformed to the frequency domain by performing FFT or MDCT.

In operation S1240, TNS is performed on the transformed residual signal (i.e., the frequency domain residual signal). If an audio signal includes a signal abruptly generated in the time domain, an encoded audio signal has noise due to, for example, a pre-echo. TNS may be performed to reduce the noise caused by the pre-echo.

In operation S1250, the TNSed residual signal is quantized. A range of a value of the residual signal may be narrower than the corresponding range of a value of the audio signal. Accordingly, if the residual signal is quantized instead of the audio signal, the audio signal may be quantized by using a smaller number of bits.

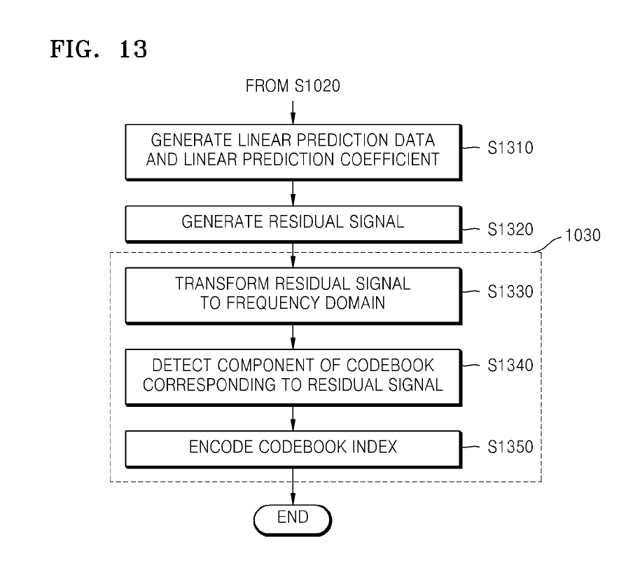

FIG. 13 is a flowchart illustrating a method for encoding an audio signal by using a codebook, according to an exemplary embodiment.

Operations S1310 and S1320 are respectively similar to corresponding operations S1210 and S1220 illustrated in FIG. 12, and thus detailed descriptions thereof will not be provided here.

In operation S1030, weighted linear prediction transformation encoding is performed on the residual signal. Operation S1030 will now be described in detail with respect to the exemplary embodiment illustrated in FIG. 13.

In operation S1330, the residual signal is transformed to the frequency domain. The residual signal may be transformed to the frequency domain by performing, for example, FFT or MDCT.

In operation S1340, a component corresponding to the transformed residual signal (i.e., the frequency domain residual signal) is detected from among components included in a codebook. The component corresponding to the residual signal may be a component which is relatively similar to the residual signal as compared with the other components included the codebook. The components of the codebook may be distributed according to a Gaussian distribution.

In operation S1350, an index of the component of the codebook corresponding to the residual signal is encoded. Accordingly, a high-quality audio signal may be encoded according to a relatively low bit rate.

While the present inventive concept has been particularly shown and described with reference to exemplary embodiments thereof, it will be understood by one of ordinary skill in the art that various changes in form and details may be made therein without departing from the spirit and scope of the invention.

The method of encoding or decoding an audio signal, according to the above-described exemplary embodiments, may be recorded in computer-readable media including program instructions for executing various operations realized by a computer. The computer readable medium may include program instructions, a data file, and a data structure, separately or cooperatively. The program instructions and the media may be those specially designed and constructed for the purposes of one or more exemplary embodiments, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as that produced by a compiler, and files containing high-level languages codes that may be executed by the computer using an interpreter. The hardware elements above may be configured to act as one or more software modules for implementing the operations described herein.

Although a few exemplary embodiments have been shown and described, the present inventive concept is not limited to the described embodiments. Instead, it would be appreciated by those skilled in the art that changes may be made to these embodiments without departing from the principles and spirit of the present disclosure, the scope of which is defined by the claims and their equivalents.

1. An audio signal encoder comprising:
a mode selection unit which selects an encoding mode relating to an audio frame;
a bit rate determination unit which determines a target bit rate of the audio frame based on the selected encoding mode; and
a weighted linear prediction transformation encoding unit which performs a weighted linear prediction transformation encoding operation on the audio frame based on the determined target bit rate.

2. The audio signal encoder of claim 1, wherein the mode selection unit selects the encoding mode from among an unvoiced weighted linear prediction transformation encoding mode and an unvoiced code-excited linear prediction (CELP) encoding mode based on a signal-to-noise ratio (SNR) of the audio frame after being encoded.

3. The audio signal encoder of claim 1, wherein the mode selection unit selects the encoding mode from among an unvoiced weighted linear prediction transformation encoding mode and an unvoiced CELP encoding mode based on a signal-to-noise ratio (SNR) of the audio frame that is encoded by varying an offset of each mode.

4. The audio signal encoder of claim 1, further comprising a code-excited linear prediction (CELP) encoding unit which performs CELP encoding on the audio frame according to the selected encoding mode.

5. The audio signal encoder of claim 4, wherein the CELP encoding unit encodes the audio frame with reference to the determined bit rate.

6. The audio signal encoder of claim 1, further comprising:
a first linear prediction unit which generates first linear prediction data by performing linear prediction on the audio frame;
a first residual signal generation unit which generates a first residual signal by removing the first linear prediction data from the audio frame;
a second linear prediction unit which generates second linear prediction data by performing linear prediction on the first residual signal; and
a second residual signal generation unit which generates a second residual signal by removing the second linear prediction data from the first residual signal,
wherein the weighted linear prediction transformation encoding unit transforms the second residual signal.

7. The audio signal encoder of claim 1, further comprising:
a linear prediction unit which generates linear prediction data by performing linear prediction on the audio frame; and
a residual signal generation unit which generates a residual signal from the audio frame,
wherein the weighted linear prediction transformation encoding unit comprises:
a frequency domain transformation unit which transforms the residual signal to a frequency domain residual signal;
a temporal noise shaping (TNS) unit which performs a TNS operation on the frequency domain residual signal; and
a quantization unit which quantizes the temporal-noise-shaped frequency domain residual signal.

8. The audio signal encoder of claim 1, further comprising:
a linear prediction unit which generates linear prediction data by performing linear prediction on the audio frame; and
a residual signal generation unit which generates a residual signal from the audio frame,
wherein the weighted linear prediction transformation encoding unit comprises:
a frequency domain transformation unit which transforms the residual signal to a frequency domain residual signal;
a detection unit which detects a component corresponding to the frequency domain residual signal from among a plurality of components included in a codebook; and
an encoding unit which encodes an index of the detected component.

9. An audio signal decoder comprising:
a bit rate determination unit which determines a bit rate of an encoded audio frame; and
a weighted linear prediction transformation decoding unit which performs a weighted linear prediction transformation decoding operation on the audio frame based on the determined bit rate.

10. The audio signal decoder of claim 9, further comprising a decoding mode determination unit which determines a decoding mode relating to the audio frame, and
wherein the bit rate determination unit determines the bit rate with reference to the determined decoding mode.

11. The audio signal decoder of claim 9, wherein the weighted linear prediction transformation decoding unit comprises:
a residual signal restoration unit which restores a second residual signal from a codebook comprising a plurality of components distributed according to a Gaussian distribution, with reference to a codebook index included in the audio frame;
a second linear prediction synthesis unit which restores second linear prediction data based on a second linear prediction coefficient included in the audio frame, and which restores a first residual signal by combining the second residual signal and the second linear prediction data; and
a first linear prediction synthesis unit which restores first linear prediction data based on a first linear prediction coefficient included in the audio frame, and which performs a linear prediction decoding operation on the audio frame by combining the first residual signal and the first linear prediction data.

12. The audio signal decoder of claim 9, wherein the weighted linear prediction transformation decoding unit comprises:
a dequantization unit which dequantizes a quantized residual signal included in the audio frame;
an inverse temporal noise shaping (TNS) unit which performs an inverse TNS operation on the dequantized residual signal;
a time domain transformation unit which transforms the inverse temporal-noise-shaped residual signal to a time domain residual signal; and
a linear prediction decoding unit which generates linear prediction data based on a linear prediction coefficient included in the audio frame, and which performs a linear prediction decoding operation on the audio frame by combining the linear prediction data and the time domain residual signal.

13. The audio signal decoder of claim 9, wherein the weighted linear prediction transformation decoding unit comprises:
an extraction unit which extracts a component from a codebook comprising a plurality of components distributed according to a Gaussian distribution, with reference to a codebook index included in the audio frame;
a time domain transformation unit which transforms the extracted component to a time domain component; and
a linear prediction decoding unit which generates linear prediction data based on a linear prediction coefficient comprised included in the audio frame, and which performs a linear prediction decoding operation on the audio frame by combining the linear prediction data and the time domain component.

14. A method for encoding an audio signal, the method comprising:
selecting an encoding mode relating to an audio frame;
determining a bit rate of the audio frame based on the selected encoding mode; and
performing weighted linear prediction transformation encoding on the audio frame based on the determined bit rate.

15. The method of claim 14, wherein the selecting of the encoding mode comprises selecting the encoding mode from among an unvoiced weighted linear prediction transformation encoding mode and an unvoiced code-excited linear prediction (CELP) encoding mode based on a signal-to-noise ratio (SNR) of the audio frame after being encoded.

16. The method of claim 14, wherein the selecting of the encoding mode comprises selecting the encoding mode from among an unvoiced weighted linear prediction transformation encoding mode and an unvoiced code-excited linear prediction (CELP) encoding mode based on a signal-to-noise ratio (SNR) of the audio frame that is encoded by varying an offset of each mode.

17. The method of claim 14, further comprising:
generating first linear prediction data by performing linear prediction on the audio frame;
generating a first residual signal by removing the first linear prediction data from the audio frame;
generating second linear prediction data by performing linear prediction on the first residual signal; and
generating a second residual signal by removing the second linear prediction data from the first residual signal,
wherein the performing of weighted linear prediction transformation encoding comprises transforming the second residual signal.

18. The method of claim 14, further comprising:
generating linear prediction data by performing linear prediction on the audio frame; and
generating a residual signal from the audio frame,
wherein the performing of weighted linear prediction transformation encoding comprises:
transforming the residual signal to a frequency domain residual signal;
performing temporal noise shaping (TNS) on the frequency domain residual signal; and
quantizing the temporal-noise-shaped frequency domain residual signal.

19. The method of claim 14, further comprising:
generating linear prediction data by performing linear prediction on the audio frame; and
generating a residual signal from the audio frame,
wherein the performing of weighted linear prediction transformation encoding comprises:
transforming the residual signal to a frequency domain residual signal;
detecting a component corresponding to the frequency domain residual signal from among a plurality of components included in a codebook; and
encoding an index of the detected component.

20. A non-transitory computer-readable recording medium having recorded thereon a program executable by a computer for performing the method of claim 14.
